(19) United States
(12) Patent Application Publication
(10) Pub. No.: US 2004/0138979 A1
(43) Pub. Date: Jul. 15, 2004

(54) Method and system for servicing an equity-based employee benefit program

(76) Inventors: Frank Juhre, Bad Soder (DE); Heather Vanderhoof, Adliswil (CH); Steve Chapman, Erlenbach (CH); Lee Khandelwal, Herrliberg (CH); Sudhir Khanna, Zurich (CH)

Correspondence Address: MICHAEL D. BEDNAREK, SHAW PITTMAN LLP, 1650 TYSONS BOULEVARD, MCLEAN, VA, 22102, US

(21) Appl. No.: 10/437,001

(22) Filed: May 14, 2003

(30) Foreign Application Priority Data
Jan. 15, 2003 (EP) 03 405 012.0

(51) Int. Cl. G06F 17/60

(52) U.S. Cl. 705/36; 705/1

(57) ABSTRACT

A method and system for servicing an equity-based employee benefit program comprising a framework services module, a participant services module, a corporate services module and an execution services module. The modules communicate with at least one database. The system has an adaptor, preferably a standard messaging adaptor, for communication with a web system and external systems, at least one of said external systems being a trade execution system. The environment of this servicing system can accommodate and communicate with any other banking, trading and administrative systems. Furthermore, the servicing system is based on an open architecture. This servicing system is very flexible, highly customizable and can meet the requirements of international companies, especially European companies.

This application claims the benefit of European Patent Application 03 405 012.0, filed Jan. 25, 2003, which is herein incorporated by reference in its entirety.

### FIELD OF THE INVENTION

The invention relates to a method and system for servicing an equity-based employee benefit program and, more particularly, to a servicing system that includes service modules and adaptors, wherein the service modules communicate with a database and the adaptors communicates with external systems, at least one of which is a trade execution system.

### DESCRIPTION OF THE RELATED ART

Some publicly owned companies are providing payment to their employees in the form of stock-based compensation, for example, equities or options to purchase shares of stock in the company at discounts from the prevailing market price. This stock-based compensation is as attractive for the companies as it is for the employees. Therefore, more and more companies are using such compensation or benefit plans.

Each of the vehicles for each grant must be individually tracked for proper delineation of such parameters as the granting, vesting, deferral, restriction exercise and expiration, distribution dates and the particular strike price for which the option was granted, respectively the cost basis for a purchased option. However, because companies have started to offer such benefit plans not only to the upper level executives but also to a greater number of employees, the managing of these compensation plans has become increasingly complex. Furthermore, since many of the corporate employees are not trading with equities often, the servicing of such plan participants is challenging the normal business systems and requires an extremely high degree of automation.

Therefore, several computer-based systems for managing employee equity-based compensation programs were developed. U.S. Published patent application 2002/0042771 discloses a method and system for managing and optimizing stock plans such as ESOPs (Employee Stock Option Plans), RSAs (Restricted Stock Award plans) and ESPPs (Employee Stock Purchase Plans) via a communication network. The system provides comprehensive services and features to the employee or participant and to the employer. The system comprises a volatile data storage for storing participant information pursuant to a data transfer from a non-volatile database of a third party's administrative system, an interface system for interacting with a participant regarding a requested transaction and enabling the participant to select a response pertaining to the employee stock plan, a trading system for conducting individual participant transactions on a public exchange, a communication system that connects a participant to the system and means for updating the participant information in the volatile data storage according to the selections and transaction made by the participant. The communication uses an interactive voice response device, an internet or an intranet interface. The system allows participating employees to view their holdings, to exercise, to hold and/or sell stock via a number of different vehicles, including cash, cashless, sell to cover, sell to raise shares, sell to raise cash or stock swap. The system also includes a reporting system that enables a corporate employer to run a report based on the participant information. This system is able to accommodate an unlimited number of participants and sponsoring employers.

U.S. Published patent application 2002/0032636 discloses a finance system for automatic processing of a transaction pursuant to at least one of a stock option plan and a stock purchase plan.

Other systems for managing stock option accounts of company sponsored stock ownership plans are disclosed in U.S. Pat. No. 6,173,270 and U.S. Pat. No. 5,671,363.

These systems are working quite well for servicing equity-based compensation plans of US companies. Because the systems originated in the US, however, these systems only reflect requirements to serve companies listed on the US stock exchanges.

The European market is not as homogenous as the U.S. market. The differences in compensation plans and instruments, regional- and country-specific legal, regulatory and tax issues, as well as country-specific differences in operation and handling, require an extremely high degree of flexibility from a system servicing employee equity-based benefit programs. Nevertheless, there are known some computer-based systems used for European companies. These systems, however, typically only focus on one single local market and do not consider all of the above-mentioned issues.

In addition, many providers of such equity-based compensation systems are banks that have their own brokerage house and trading departments and are concentrated on single markets.

U.S. Pat. No. 6,411,939 discloses a system servicing an employee benefit program for US multi-national employers. Especially when “qualified” and “non-qualified” benefits are offered by the company, not all of the benefits can be offered in other countries for economic and tax reasons. This system is intended to enable a fair and equal compensation program to all employees, including employees outside the U.S. This system is therefore deemed to be able to consider different tax and law systems. However, this system is still only adapted to U.S. companies and does not fulfill the requirements of a European based international corporation.

Furthermore, a computer-based system for servicing an equity-based employee benefit program should meet the requirements of the corporation as well as the requirements of the employees, i.e., the individual participants. The individual participants require user-friendly information services while assets are restricted and financial advice regarding plan events is complemented by alternative and structured investment offerings. Furthermore, the above mentioned needs can vary. The present systems, however, are quite fixed and cannot be adapted to changing requirements. Automatic trading is only implemented for the U.S. exchanges or the local country exchange for providers in local jurisdictions.

### SUMMARY OF THE INVENTION

It is therefore an object of the invention to provide a method and system for servicing an equity-based employee benefit program that are more flexible and can therefore meet the needs of multinational corporations and their employees. The invention is linkable to any banking system and especially meets the needs of corporations based in the European market, preferably in the EU5 (Germany, Spain, Italy, United Kingdom and France) and in the Swiss Market.

According to an embodiment of the present invention, this object is achieved by a computer-based servicing system for servicing at least one equity-based employee benefit program. According to the embodiment, the system includes a framework services module, a participant services module, a corporate services module and an execution services module. At least one of the modules communicates with at least one database. The system has an adaptor for communication with external systems. At least one of the external systems is a trade execution system.

The computer-based servicing system according to the invention does not use rigid links for communication with external systems, contrary to the systems of the prior art. The inventive servicing system includes multiple standard messaging adaptors to enable the use of standard messaging interfaces for communication with multiple external systems, such as web systems, trading systems and information systems.

In particular, the servicing system according to the invention does not use rigid links to brokerage and settlement systems, but instead uses multiple standard messaging protocols, which are used to inter-connect brokers, settlement providers and custodians to allow for communication with any provider offering the services required to effect execution and settlement of plan related vehicles.

The servicing system according to the invention is built in an open architecture and uses customizable tables and templates. It can therefore be easily changed to reflect all multi-national requirements (especially the European requirements) driven by the corporation as well as by the participants, which provides an even more flexible servicing system. Online administration is available so that administrators can change data in real-time. As there is no volatile database, the complexity of the imports and export of data between the servicing system and external systems is decreased.

The servicing system is able to handle more than one financial instrument, including, for example, options, warrants, convertible bonds, and share grants.

Additionally, grants may be set up to include multiple vehicles. These different financial instruments are managed in the same data structure to ensure consistency in reporting and viewing. It is possible, however, to make a difference between the different financial instruments for reporting and plan management. This is achieved by gathering all relevant information on the plans at a greater level of granularity and making the associations with this granularity to business rules that are templated in the servicing system and configurable by the corporation.

The servicing system provides online means for corporate users to administer their global benefit plans and logic to meet taxation and reporting requirements for these plans. These reporting means facilitate the reporting to regulators, internal corporate departments and plan participants.

Additionally, the servicing system provides for online information and trade requests by the participants of the benefit plans with straight-through execution to exchanges and targeted communication functionality. In addition, the servicing system enables multi-lingual access for participants to the plans. The execution can be handled through web, call center and/or a financial advisor network. The system enables a straight-through processing of executions to any major stock exchange and enables trading in multiple currencies.

An innovative processing logic takes ordinarily non-tradable vehicles and allows the realization of cash and securities. This is achieved through the definition of business processes that allows transaction instructions to be sent through to the trading and settlement platforms. The interfaces themselves are designed to allow complete inter-changeability between single or multiple execution, settlement and custody providers, whilst retaining the automated processing that gives real time pricing and fulfillment on transactions. The interfaces allow for the provision of trading and settlement across multiple exchanges, brokers and transaction service providers.

The servicing system according to the invention can be used by corporations that have stock listings in more than one market, especially in more than one European market, and employees in multiple locations. The corporation can have multiple plan types requiring the processing of multiple asset types, wherein a single participant, i.e., an employee of the corporation, can participate in multiple plans. The company can offer in these plans shares, options and a multiple of alternative investment instruments and vehicles. It includes, for example, administration of employee stock option plan (ESOP), employee stock purchase plan (ESPP) and restricted stock awards (RSA) warrants, convertible bonds and share grants. The investment instruments and vehicles are, for example, trade instruments, such as shares and warrants, as well as non-tradable instruments, such as American style options, European style options, SARs and phantom shares.

### BRIEF DESCRIPTION OF THE DRAWING

In the following, a preferred embodiment of the invention is explained with reference to the drawings.

FIG. 1 is a schematic diagram of a general view of an exemplary web-application set-up including a servicing system, according to the present invention.

FIG. 2 a more detailed schematic diagram of the servicing system embedded in the web application set up.

FIG. 3 is a schematic diagram of a general view of the servicing system with its interfaces.

FIG. 4 is a schematic diagram of a general view of the servicing system in a multi-corporation application.

FIG. 5 is a schematic diagram of a general view of an exemplary execution and settlement procedure using the inventive servicing system.

FIG. 6 is a schematic diagram showing the multiple single steps used in the execution and settlement procedure according to FIG. 5.

FIG. 7 is a schematic diagram of a general view of the data flow from and to the inventive servicing system during the procedure according to FIG. 5.

### DETAILED DESCRIPTION OF A PREFERRED EMBODIMENT

### System Architecture

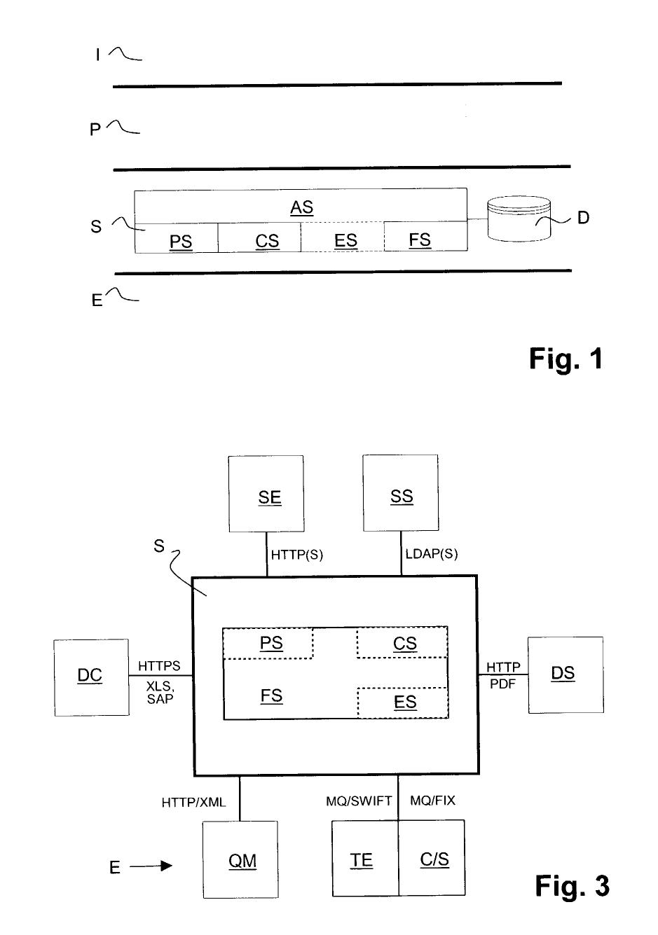

FIG. 1 shows a simplified web-application set-up including the inventive computer-based servicing system S for servicing an employee equity-based compensation program of a corporation.

This servicing system S is connectable through an application server or manager AS by Proxy P, for example, a safe reverse Proxy, with the Internet I. It is also connectable to external systems E, such as corporate databases and banking systems.

The servicing system S includes at least one internal database D. The data used for the inventive system S are stored within this database D. For database D, a known database can be used, such as an Oracle database. The servicing system S further includes at least four main modules: a Framework Services Module FS, a Participant Services Module PS, a Corporate Services Module CS and an Execution Services Module ES.

The Framework Services Module FS wraps the other modules of the servicing system S. Some framework services are used externally, i.e., authentication services. In this case, the framework services are at a level higher than the services of the other modules. Other framework services are used by the servicing system S itself, in which case they are located at a lower level or on the same level as the services of the other modules.

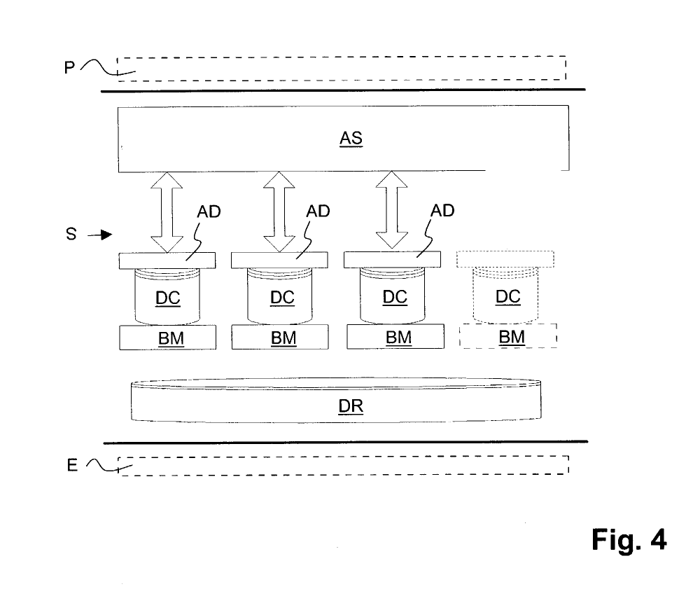

Preferably, the servicing system S can be used for one corporation only. The servicing system S according to the invention can, however, also be used for multiple corporations, as is shown in FIG. 4.

In case of the servicing system S being used by multiple corporations, instead of one single database D, a database DC for each company is used, as well as a central database DR. Each company is set up within its own company database DC, where all data related to the company are stored. Each company database DC contains the main business logic, which is encapsulated within a PL/SQL stored procedure layer. All data used by the system S, for example, reference data such as countries and currencies, are also stored in the central database DR, which incorporates central reference data as well as external interface data. A web-based system administration application manages the central reference data interactively. Modifications to the central reference data are propagated to each of the company databases DC.

Batch modules BM, as shown in FIG. 4, are used to manage company reference data non-interactively. Once the application server AS gets a request, a login proxy or router service identifies the user's company membership by reading the company identification stored by the Proxy P within a HTTP header. With the company identification in hand, the application server AS then determines which database DC connection to use. The corresponding connection parameters are stored within a configuration file. This separation of data is made for security reasons as well as for technical reasons, since the access to company-specific data is made easier.

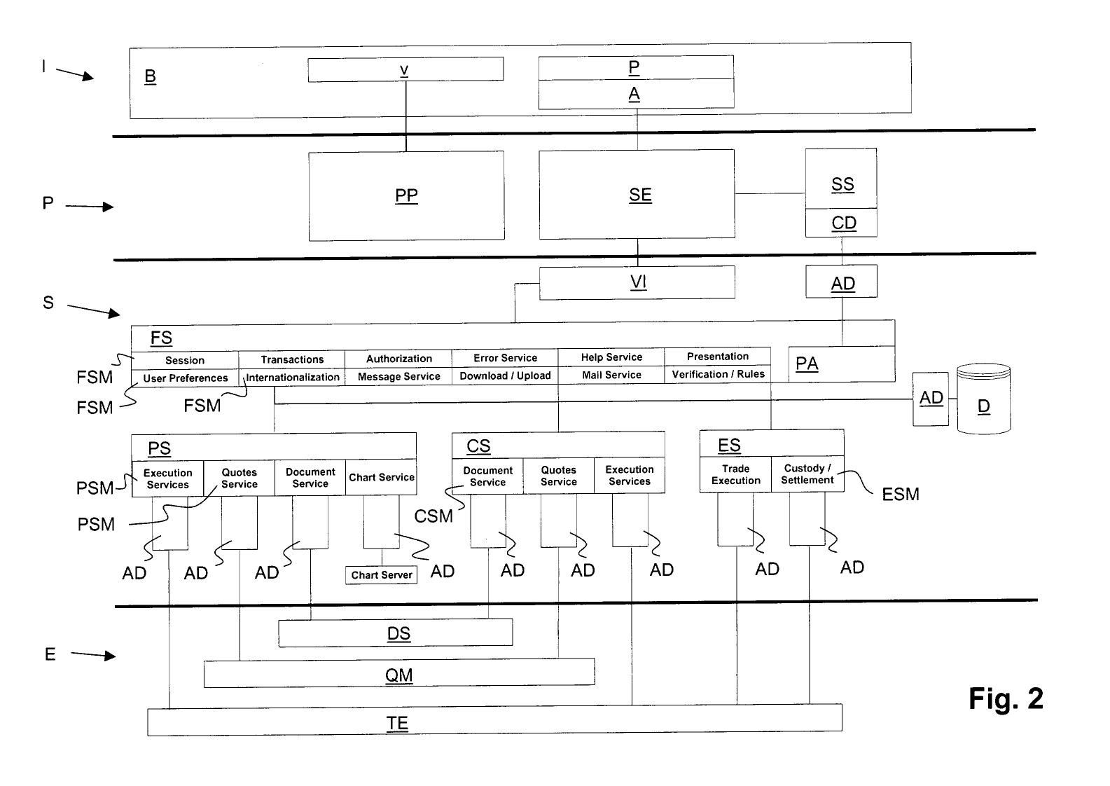

In the following, the system architecture is described in more detail with reference to FIG. 2. The description is structured top-down, from the Internet I and browser-level B, down to the external systems E.

On the browser level B, a visitor V can enter a public portal PP and contact the company providing the servicing system S. For a corporation or company that is already a client of the servicing system S, the company's administrator A can access the servicing system from the Internet I using a secure entry module SE by entering his password. A participating employee P of the corporation can do the same. The secure entry module SE is responsible for the authentication, URL redirection and the session management across the system. The safe entry module SE also provides means for choosing the session within the system S, for changing the password and for help in case the participant P or the administrator A forgot his password. If the password is not known, the user P, A is routed to a safe server SS, enabling the change of password. The access is then routed by an adaptor AD, for example, an LDAP adaptor, to a Credential Services Sub-module PA of the Framework Services Module FS. The safe server SS is also the access point to a critical data storage CD, here a LPDA Server, and is responsible for storing the user's information such as the identification, the password and the company membership.

If the password is correct, the corporation is identified through a standard Login Proxy and Verification interface VI and the user, i.e., the participant or the corporation administrator, is routed to the part of the servicing system S belonging to this corporation. The participant P is also routed according to the granted benefit plans, the currency he is familiar with and the language he is speaking.

As was mentioned before, the servicing system S includes the Framework Services Module FS and three other modules, i.e., the Participant Services Module PS, the Corporate Services Module CS and the Execution Services Module ES.

The Framework Services Module FS includes a multiple Framework Services Sub-modules FSM as listed in FIG. 2, which includes, for example, submodule servicing session, user preferences, transactions, internationalization, authorization, etc.

The servicing session sub-module FSM keeps track of any conversational data and verifies the session's lifecycle. In the user preferences sub-module FSM, the user's preferences are stored. The transactions sub-module FSM is responsible for performing ACID operations. The internationalization sub-module FSM takes care of local specific issues, so that the servicing system S can be used in a multilingual/multi-currency market. The authorization sub-module FSM is based on roles and checks the roles the user P, A belongs to. In a rules framework services sub-module FSM, all corporation-wide relevant rules are defined. Such rules are rules for importing and exporting files; rules for actions for participant status values and beneficiary actions; rules when approvals are required; residual cash management rules; rules about report properties; rules for event monitoring and notification; dividend rules; rules for overwriting of participant address/phone/email; rules for locking accounts; quotes requirements in real time or delayed and their implication on cost; rules for resetting passwords; and authorization rules and functionality.

The Participant Services Module PS includes multiple Participant Services Sub-modules PSM as listed in FIG. 2, for example, an execution services sub-module PSM, a quotes services sub-module PSM, a documents service sub-module PSM and a chart service sub-module PSM. The Participant Services Module PS allows the participant P to navigate within the appropriate areas of the application. Universal and multilingual navigation is possible. Furthermore, the Participant Services Module PS includes one or more of the following features:

Login, password and security management

Participant core data/personal detail management

Agreement management

Report and statement of participant positions in the invested instruments (multiple views and sorts)

Personal page administration, including To Dos

order entry, review and verification

preferences

Stock market quotes

Support, Help and frequently asked questions (FAQs)

modeling (x-vehicles)

The chart service sub-module PSM of the Participant Services Module PS is connected to a chart server, which enables presentation of diagrams of quotes. The chart server is preferably part of the inventive servicing system S. However, it can also be an external system.

The Corporate Services Module CS includes or is connected to the internal database, or in the case of multiple corporations, to the company databases DC. As mentioned before, these databases DC are exclusively adapted to the needs and rules of the corporations. In a Corporation Servicing Sub-module CSM of the Corporate Services Module CS, all corporation-generic information such as identifier, WEB, logos etc. is stored. Furthermore, it includes information about the invested instruments, vehicles and underlying securities, trusts, payrolls, organization structures and security organization parameters. The different accounts, such as corporate cash and depot and payroll cash accounts are defined therein, as well as corporation related codes, for example, the rank and the participant type. This sub-module CSM also includes the tax information. Documentation services, Execution Services and Quotes are part of Participant Services PS as well as Corporate Services CS.

The Execution Services Module ES guarantees a full straight-through processing. It includes an Execution Services Sub-module ESM for trade execution and an Execution Services Sub-module ESM for custody and settlement. These are separate modules, which can be called by the Participant Services PS as well as by the Corporate Services CS, the Participant Services PS for order placing and review and the Corporate Services CS for setup and reporting.

The above-mentioned external systems E are, for example, a document storage DS, a Quotes Market Data Service System QM and a Trade Execution System TE, as shown in FIG. 2. The document storage DS is used to keep, for example, pdf's, statements and other communications sent by the bank, either directly or upon company request to the participant P. The document storage DS can also be an internal part of the servicing system S itself. The Quotes Market Data Service System QM is a platform to obtain market information, such as the prices of the equities. Normally, it is used as a read-only system from the servicing system S. The Quotes Market Data Service System QM is not responsible for storing any data of the servicing system S. The External Trade Execution System TE is used for trading.

In accordance with the invention, the servicing system S is connected through standard messaging interfaces to all external systems as well as to all internal databases D, DR, DC and servers. As can be seen in FIG. 2, each module of the system S has its own adaptor AD for using standard messaging interfaces to their corresponding module of the external systems. The database D or the central database DR and the companies databases DC are, for example, connected with the Servicing Modules by a PL/SQL adaptor AD. As an interface to a Chart Server, a j Class API adaptor AD is used. The Quotes Market Data Service System QM is connected by MADIS adaptors AD, the document storage DS by Doc-Store adaptors AD. The Trade Execution System TE is connected by an execution services adaptor AD such as a FIX adaptor, a SWIFT messaging adaptor and a Cash Message adaptor.

In FIG. 3, the servicing system S, its interfaces and the external systems E are shown in a different representation, wherein the same modules are designated with the same reference numbers as in the other figures. This representation shows the standard protocols and interactions used for communication with the external systems and databases. The protocols and interactions depend on the category of these external systems and databases. In this embodiment, HTTP/XML, HTTPS, XLS, SAP, MQ/SWIFT, MQ/Fix, PDF and LDPAP(S) are used.

### Customizable Administration

The servicing system S according to the invention is highly customizable by the corporations. This customization is achieved by using an open architecture for the servicing system S and especially by using customizable data tables and templates.

Once these mentioned tables and templates are created, the servicing system S provides the company with the ability to further customize the service, but does not allow for conflicting requirements based on logic within the system. This flexible handling is linked to a set of validation rules and core functionality to prevent the corporation or the service providing company from building illogical or conflicting set-ups. The servicing system S also considers global legal and tax requirements. This feature is achieved through overlaying company, plan, grant, vest logic, and eligibilities as base level parameters, with employee lifecycle events, country specific requirements, exchange specific rules, regulatory and tax information on top. Any items that conflict with each other are kicked out and managed. Access and authorization are based on a similar principle. User roles are defined on a function-by-function level as well as data level entitlement by a column and row based access.

The company is in a position to customize the company's system as well as the central reference data. The customization of the company's data can easily be done by changing the data in the corporation database DC. The company data-base DC also has parameters that dictate how execution can happen. These parameters are, for example, customizable by country, exchange and plan, as well as by vehicle and currencies.

If a company wishes to change any central reference data, a local reference data table entry is created. This local reference data table is preferably stored in the corporation database DC. An attribute (Modify_Type) indicates the type of customizing undertaken: a new entry, modification of an existing entry or a “deletion” of an existing entry. Below, an example of the three types of modifications is given. In this example, a country table is customized:

(1) If the company wishes to add a dummy country, then this country is inserted into a local country table of that company and the attribute Modify_Type for this entry contains the value “new.” All the programs that access the country table treat this new dummy country as though it is present in the central reference data.

(2) If a company wishes to modify an attribute of a reference data entry, a new row is inserted in the local reference data table with the same key as that in the central reference data table and the attribute Modify_Type for this entry contains the value “mod.” All the programs that access the reference data will fetch the row from this table and not from the central reference data table. This entry in the local table will not get updated when the central reference data are changed.

(3) If a company wishes to remove a country from the country table, a new row is inserted and the attribute Modify_Type for this entry contains the value “del.” All the programs that access the reference data will not fetch the entry corresponding to this country from the central reference data table. This entry in the local table will not get updated when the central reference data are changed.

The inventive servicing system S is furthermore able to manage more than one financial instrument in the same data structure. By generalizing naming conventions and taking the maximum set of parameters across financial instruments that are used for compensation, the servicing systems is able to manage a transaction on a variety of instruments. This functionality is achieved by gathering all relevant information on the plans at a higher level of granularity and making associations with this granularity to business rules that are templated in the servicing system and configurable by the corporations.

For example, the corporation can have many plans and each plan can have many vehicles, for example, a stock option and a stock purchase share. Grants or participations are set up to accommodate this level of flexibility. Additionally, the system allows for the recording and processing of mobile populations by keeping track of the taxable events, location of participants at points in the plan, participation, grant and employee lifecycles. This information is reportable to the corporation and to the participant so that they can comply with local tax rules and regulatory requirements.

Another example of this customizable structure is the ability to set up a variety of distribution methods within one company and even within a plan. Business procedures are divided into multiple logical single steps that reflect the processing of trades, cash and stock settlements. Transaction instructions can be customized to give specific instructions to the broker for the handling of trades. For example, trades can be instructed for automatic execution without the manual interference of a trader. For example, the company can choose to have trades processed through a straight-through processing, with orders being sent one-by-one to the exchange, and for other plans/grants to be processed via daily batch trading based on the days trade requests of based on elections made by the participant over a period of time. This functionality can be used by any company, plan, grant in the servicing system S and is changeable post-implementation.

### Trade Links For Straight-Through Execution

As was mentioned before, the inventive servicing system S has interfaces that are portable to any financial services provider. This gives the inventive system S the ability to execute on any exchange, through the broker's membership, and to settle with any provider, be it the same entity as the execution provider or otherwise.

The use of a standard protocol like FIX and SWIFT for the external trade execution enables straight through execution services (STP) for trade execution, custody and settlement.

The business process itself is broken down into multiple single steps consisting of logical standard banking transactions. This ensures maximum efficiency and portability to any provider both on the execution and settlement sides, as is explained in the following.

Modeling is based on indicative market conditions, which gives the plan participant as accurate a likely outcome as possible.

Order capture is simplified such that, for example, once a participant has elected to Exercise, Exersell, or Sell to Cover their options positions, a series of transaction processes are initiated automatically.

If a market order is generated and delivered through the FIX interface to the broker, the fulfillment by the broker is captured in real time and displayed to the participant so that he has a continual commentary on the status of the execution. When it is completed, the previously unknown value, i.e., the quantity and the price, becomes known.

If an option shall be exercised, the inventive system S calculates the required Exercise quantities based on the market execution and allocates these to the lowest level within the participant's portfolio. In this case, a standard message is delivered to a registrar or a custody provider to deliver the stock against the corporate's treasury account.

Cash journals are updated by generating journal instructions to distribute the execution proceeds across the corporate's treasury, the corporate's payroll accounts, and the fee accounts.

Stock delivery instructions are delivered to the custodian to distribute the residual securities to the plan participant.

Cash payment instructions are delivered to the custodian to distribute the residual cash to the plan participant.

The books and records at the custodian record the receipt and delivery of cash and securities that mirrors the activity on the inventive system S.

The inventive system S itself includes books and records that record the option position in relation to the transaction activity at the lowest possible level, as well as the movement of cash and securities at the custodian.

Reconciliation reports are generated by the custodian in the form of SWIFT messages that are delivered through the before-mentioned SWIFT messaging adaptor AD. Reconciliation reports are generated by the servicing system S in terms of the expected movements at the custodian based on the trade instruction. The reports are run through a reconciliation engine with exceptions being managed by the business's operations unit.

The fulfillment on execution prior to the generation of the settlement instructions allows the servicing system S to process settlement requirements that exactly match the movements at the custodian.

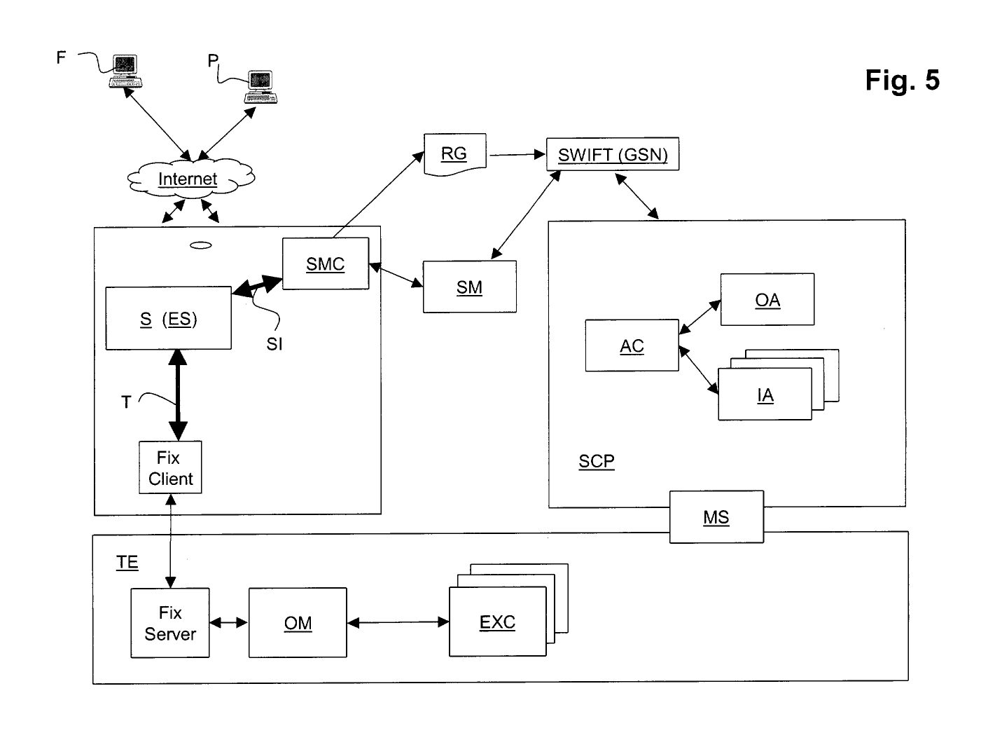

In FIG. 5, an automatic execution and settlement procedure using the Execution Services Module ES of the servicing system S is shown. If an order T is generated in the servicing system S by the participant P, a FIX instruction including an account number of a FIX client is sent to the external trading system TE of a bank. The account number can represent an individual account or an omnibus bulked account. Since industry standard messaging interfaces are used, the participant P and/or the corporation F is allowed to define the handling rules and routing instructions for orders on an individual basis.

The external trading system TE feeds via a FIX Server an order management system OM. This order management system OM sends the order to an exchange EXC chosen for execution and receives back details of the fills as they happen. The order management system OM delivers the fill information to the servicing system S via the FIX interface. At the completion of the execution, the servicing system S sends the trade details SI through a SWIFT messaging client SMC to the registrar RG, which sends the information through SWIFT(GSN) to the settlement and custody provider SCP. In this example, the settlement and custody provider SCP includes fee accounts A, omnibus accounts OA and individual accounts IA. When the settlement and custody provider SCP has performed the trade enrichment, the adapted information is sent back through SWIFT(GSN) and a SWIFT messaging system SM to the servicing system S. The market settlement MS is made directly from the settlement and custody provider SCP with the external trading system TE.

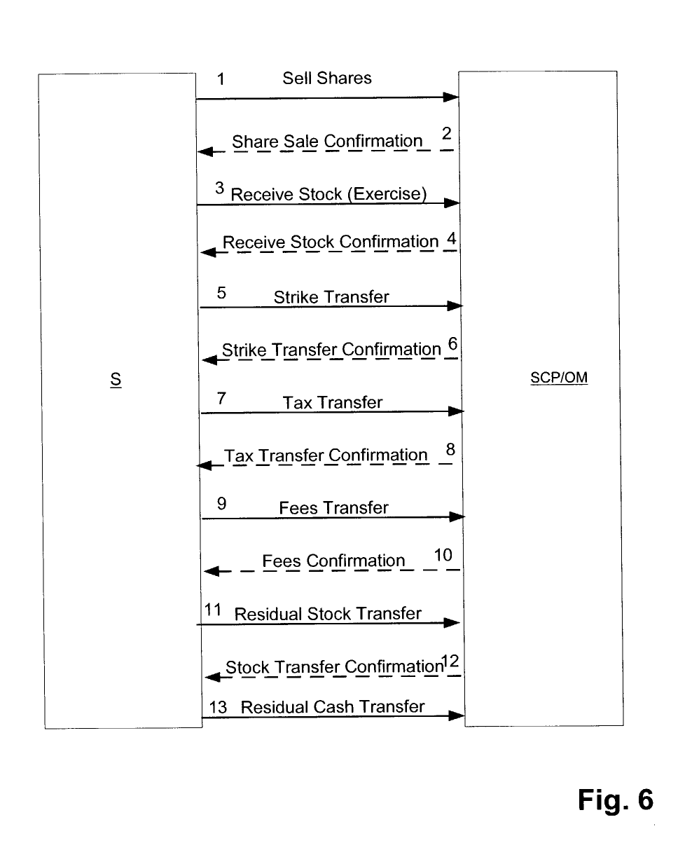

In FIG. 6, the above-mentioned automatic execution and settlement process is shown in a different way, explaining now the different steps taken. The settlement and custody provider SCP and the trade execution are in this figure incorporated in the same symbol called SCP/OM.

As shown, execution instructions 1 are sent from the servicing system S through the FIX interface to the order management OM, namely a broker. An execution advice 2 is sent back from the broker through the FIX interface to the servicing system S. The exercise instruction 3 against the corporation F is sent from the servicing system S directly to the registrar RG. Usually, these requests will be limited in time per corporate client to limit processing requirements and external communications. For example, it can be limited to once daily.

From the book-keeping system of the settlement and custody provider SCP, a stock receipt advice 4 will be sent to the servicing system S, which will also include the servicing system S internal transaction and participant reference. In the fifth step, an instruction 5 to debit the participant account and credit the corporate strike account will be sent, the instruction will once again include the transaction and participant reference. A confirmation 6 of the journal instruction execution, including the transaction and participant reference, will be returned to the system.

Now, the instruction 7 to debit the participant account and credit the corporate payroll account will follow. The confirmation 8 of journal instruction execution, including tax transfer, is sent, which is followed by the confirmation 10 of journal execution including fees transfer. Now an instruction 11 to deliver cash to a re-investment account, which can be a third party bank account or an internal bank account of the bank providing the servicing system, is delivered. Last but not least, a confirmation 12 concerning the cash transfer is sent to the servicing system and a residual cash transfer 13 is conducted.

All the above mentioned confirmations and instructions 3-13 always include the servicing system transaction and participant reference number. Other transactions are handled in a similar way, wherein the different instructions and confirmations are processed step-by-step to enable a fully automatic handling and trading.

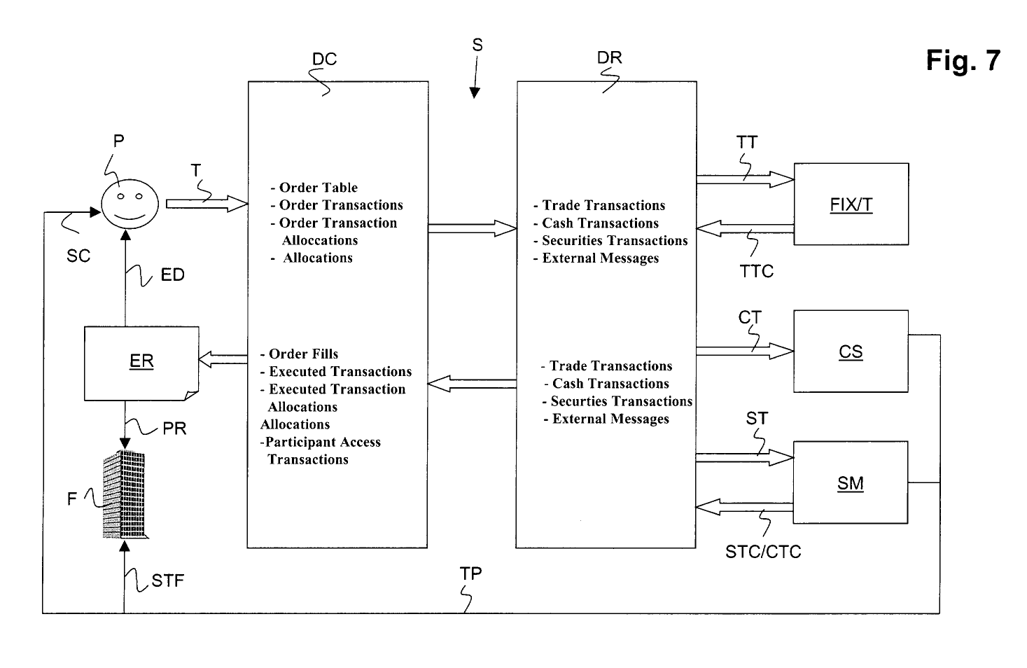

In FIG. 7, it is shown how the corporate and the central database DC, DR are used during such a transaction. T is once again the order entered by the participant P into the servicing system S. The servicing system S is here only represented by the corporate database DC and the central database DR. FIX/T is the external trading module, TT is a trade transaction, and TTC is a trade transaction confirmation. CST is the external cash settlement system. CT means the cash transaction and TP means the transactions proceedings. SM is the SWIFT messaging adaptor used. ST means the securities transactions and STC/CTC means the securities transactions confirmations and the cash transactions confirmations. STF is the strike, taxes and fees and ER is the execution report sent from the servicing system S to the company F, for example, in a payroll report PR. SC means the information sent to the participant P concerning cash, shares, etc.

The servicing system S according to the invention is very flexible, highly customizable and can meet the requirements of international companies, especially European companies.

The following list of reference symbols is provided for convenience:

List of Reference Symbols

I Internet

CD Critical Data Storage

P Proxy

PP Public Portal

SE Secure Entry Module

SS Safe Server

V Visitor

P Participant

A Company's Administrator

F Company

S Servicing System

AS Application Server

VI Verification Interface

FS Framework Services Module

FSM Framework Services Sub-module

PA Credential Services Sub-module

PS Participant Services Module

PSM Participant Services Sub-module

CS Corporate Services Module

CSM Corporate Services Sub-module

ES Execution Services Module

ESM Execution Services Sub-module

BM Batch Modules

AD Adaptor

PA Credential Services Sub-module

D Database

DC Corporate Database

DR Central Database

E External Systems

DS Document Storage

QM Quotes Market Data Service System

TE External Trade Execution System

T Trade Order

OM Order Management System

EXC Exchange

SMC SWIFT messaging client

SM SWIFT messaging

RG Registrar

SCP Settlement and Custody Provider

AC Account

OA Omnibus Account

IA Individual Account

MS Market Settlement

TT Trade Transaction

FIX/T external trading module

TTC Trade Transaction Confirmation

CST External Cash Settlement Module

CT Cash Transaction

TP Transaction Proceedings

ST Securities Transactions

STC/CTC Securities Transactions Confirmations

STF Strike Taxes and Fees

ER Execution Report

PR Payroll Report

SC Information

The foregoing disclosure of the preferred embodiments of the present invention has been presented for purposes of illustration and description. It is not intended to be exhaustive or to limit the invention to the precise forms disclosed.

Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A computer-based servicing system for servicing at least one equity-based employee benefit program, the system comprising a framework services module, a participant services module, a corporate services module and an execution services module, wherein at least one of the modules communicates with at least one database and wherein the system has standard messaging adaptors for communication with external systems, at least one of said external systems being a trade execution system.

2. The servicing system according to claim 1, wherein all said adaptors are standard messaging adaptors.

3. The servicing system according to claim 1, wherein said system has a multiple of standard messaging adaptors, each of said standard messaging adaptor corresponds to an external system, of the at least one of said external systems, with which a communication has to be established.

4. The servicing system according to claim 1, wherein said adaptors use one of HTTP/XML, HTTPS, XLS, SAP, MQ/SWIFT, MQ/FIX, PDF and LDPAP(S) protocols.

5. The servicing system according to claim 1, wherein at least one of said at least one database is an internal database of said servicing system.

6. The servicing system according to claim 1, wherein said at least one database is at least one corporate database and at least one central database, wherein data related to a company are stored in the corporate database, and wherein central reference data and external interface data are stored in the central database.

7. The servicing system according to claim 1, wherein said servicing system has an open architecture.

8. The servicing system according to claim 1, wherein said at least one database comprises customizable tables and templates.

9. The servicing system according to claim 1, wherein said at least one database is at least one corporate database and at least one central database, wherein data related to a company are stored in the corporate database, wherein central reference data and external interface data are stored in the central database, wherein said at least one database comprises customisable tables and templates, and wherein the customizable tables and templates are stored in the at least one corporate database.

10. The servicing system according to claim 6, wherein the servicing system treats changes in the corporate database as being existent in the central database.

11. The servicing system according to claim 1, wherein the servicing system gathers relevant information on plans of the at least one benefit program and associates the relevant information with business rules, the business rules being templated in one of the modules.

12. The servicing system according to claim 1, wherein the servicing system executes and settles a trade using standardized steps only, and wherein said servicing system communicates with the external trade execution system and any other external system necessary to execute and settle a trade.

13. The servicing system according to claim 12, wherein the standardized steps correspond to existing banking processes.

14. The servicing system according to claim 13, wherein the servicing system processes the execution and settlement of the trade as well as tax calculation and reporting automatically.

15. A method for servicing at least one equity-based employee benefit program, the method comprising:
communicating with external systems using a framework services module, a participant services module, a corporate services module, an execution services module and at least one database and using standard messaging adaptors, wherein at least one of said external systems is a trade execution system, and
communicating with the at least one database using at least one of the group of the framework services module, the participant services module, the corporate services module and the execution services module.

16. The method of claim 15, wherein said standard messaging interfaces use at least two of HTTP/XML, HTTPS, XLS, SAP, MQ/SWIFT, MQ/FIX, PDF and LDPAP(S) protocols.

17. The method of claim 15, wherein the method comprising:
receiving an order from a plan participant;
transmitting an instruction through one of a plurality of standard messaging interfaces to an external trading system;
receiving fill information from the external trading system via the one standard messaging interface;
forwarding the trade information to a settlement and custody provider; and receiving adapted trade information from the settlement and custody provider, wherein the instruction is in FIX protocol and includes an account number of a FIX client.

18. The method of claim 17, wherein the account number represents one of an individual account and an omnibus bulked account.

19. The method of claim 17, wherein the trade information is forwarded to the settlement and custody provider through a registrar.

20. The method of claim 19, wherein the trade information is forwarded through a SWIFT messaging client to the registrar, and wherein the registrar forwards the trade information to the settlement and custody provider through a SWIFT(GSN).

21. The method of claim 17, wherein the adapted trade information is received from the settlement and custody provider through a SWIFT(GSN) and a SWIFT messaging system.

22. The method of claim 17, wherein market settlement is made directly from the settlement and custody provider with the external trading system.

23. A method for servicing at least one equity-based employee benefit program from a servicing system, the method comprising:
transmitting an execution instruction to an order management system;
receiving an execution confirmation from the order management system;
transmitting an exercise instruction against the corporation to a registrar;
receiving a stock confirmation from a settlement and custody provider;
transmitting a strike transfer instruction to the order management system; and
receiving a strike transfer confirmation from the order management system,
wherein the transmission and receptions are accomplished using multiple standard messaging protocols.

24. The method of claim 23, further comprising:
receiving a strike transfer confirmation from the order management system;
transmitting a tax transfer instruction to the order management system;
receiving a tax transfer confirmation from the order management system;
transmitting a fee transfer instruction to the order management system;
receiving a fee transfer confirmation from the order management system;
transmitting a residual stock transfer instruction to the order management system;
receiving a residual stock transfer confirmation from the order management system; and
transmitting a residual cash transfer instruction to the order management system.

25. The method of claim 23, wherein the multiple standard messaging protocols facilitate communication with web systems, trading systems, and information systems.

26. The method of claim 23, wherein each transmission and reception includes a transaction and participant reference.

27. The method of claim 23, wherein the execution instruction is for a participant and is to be applied against a corporation, and wherein the strike transfer instruction requires debiting an account of the participant and crediting a strike account of the corporation.

28. The method of claim 23, wherein the transmissions and receptions occur automatically.

29. The method of claim 23, wherein the multiple standard messaging protocols include at least two of HTTP/XML, HTTPS, XLS, SAP, MQ/SWIFT, MQ/FIX, PDF and LDPAP(S).
